(19) United States
(12) Patent Application Publication
(10) Pub. No.: US 2026/0124857 A1
(43) Pub. Date: May 7, 2026

(54) INTEGRATED WASHER SLINGER WITH ANTI CREVICE CORROSION FEATURE FOR A DRIVE LINE COMPONENT OF A VEHICLE

(71) Applicant: GM GLOBAL TECHNOLOGY OPERATIONS LLC, Detroit, MI (US)

(72) Inventors: Brian Michael VALOVICK, Oxford, MI (US); Philip J. FIKANY, Troy, MI (US); Avissai ALCANTARA, Sterling Heights, MI (US); Arthur C. VALVERDE, Macomb, MI (US); Fabian CLEMENS, Romeo, MI (US)

(21) Appl. No.: 18/934,769

(22) Filed: Nov. 1, 2024

(51) Int. Cl. B60B 27/06; B60B 27/00; B60B 35/14; B60B 35/16

(52) U.S. Cl. CPC B60B 27/065; B60B 27/0015; B60B 35/14; B60B 35/16; B60B 2310/316; B60B 2360/50; B60B 2900/113; B60B 2900/133; B60B 2900/141; B60B 2900/211; B60B 2900/321; B60B 2900/531

(57) ABSTRACT

A drive line component for a vehicle includes a half shaft including a housing having an axially outwardly facing surface, a wheel hub assembly including a wheel bearing having an axially inwardly facing surface, and a ring extending about the housing. The ring including a radially inwardly projecting flange portion arranged between the axially outwardly facing surface of the half shaft housing and the axially inwardly facing surface of the wheel bearing, a radially outwardly projecting flange portion, and a transition region extending between the radially inwardly projecting flange portion and the radially outwardly projecting flange portion. The transition region includes a first portion extending axially inwardly from the radially inwardly projecting flange portion, a second portion extending at an angle toward the radially outwardly projecting flange portion, and a third portion including a transition between the first portion and the second portion. The transition having a sharp edge.

### FIELD

The present disclosure relates to the art of vehicles and, more particularly, to a half shaft assembly for a vehicle drive line component having an integrated washer including an anti crevice corrosion feature.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A drive unit serves as an interface between a vehicle motor and a drive train. Often, the drive unit itself will house an electric motor that is connected to a gear train. The gear train may be controlled to produce various gear ratios that control vehicle speed. The drive unit is connected to a first wheel through a first half shaft and to a second wheel through a second half shaft. Each half shaft cooperates with a wheel bearing to rotate the associated wheel mounted to the wheel bearing. During torque transitions, a joint housing of the half shaft may move into contact with the bearing. This metal-to-metal contact may produce a clicking noise.

### SUMMARY

A drive line component for a vehicle, in accordance with the present disclosure, includes a half shaft including a housing having an axially outwardly facing surface, a wheel hub assembly including a wheel bearing having an axially inwardly facing surface, and a ring extending about the housing of the half shaft. The ring including a radially inwardly projecting flange portion arranged between the axially outwardly facing surface of the half shaft housing and the axially inwardly facing surface of the wheel bearing, a radially outwardly projecting flange portion, and a transition region extending between the radially inwardly projecting flange portion and the radially outwardly projecting flange portion. The transition region includes a first portion extending axially inwardly from the radially inwardly projecting flange portion, a second portion extending at an angle toward the radially outwardly projecting flange portion, and a third portion including a transition between the first portion of the transition region and the second portion of the transition region. The transition having a sharp edge.

In other features, the sharp edge forms a substantially 90° angle.

In other features, the housing of the half shaft includes a surface extending axially between the axially outwardly facing surface and a radially outwardly projecting portion, the transition being arranged closer to the axially outwardly facing surface than to the radially outwardly projecting portion.

In other features, the transition reduces moisture retention between the ring and the housing of the half shaft.

In other features, the surface at the axially outwardly facing surface of the housing includes a first thickness portion and the surface adjacent the radially outwardly projecting portion includes a second thickness portion the second thickness portion having a thickness that is less than the first thickness portion, the transition reducing moisture accumulation on the surface adjacent the second thickness portion.

In other features, the ring is formed from a resilient material.

In other features, the housing of the half shaft includes an outer diameter, and the ring includes an opening having an inner diameter that is smaller than the outer diameter to facilitate a press-fit between the ring and the housing of the half shaft.

In other features, the second portion of the transition region extends at an acute angle between the sharp edge and the radially outwardly projecting flange portion.

In other features, a fastener is configured to secure the wheel bearing to the half shaft, the fastener being torqued to a first selected torque value, a second torque value that is less than the first selected torque value.

In other features, the wheel hub assembly includes an opening surrounded by a recess, the opening being configured to receive the housing of the half shaft and the recess being configured to receive the radially outwardly projecting flange portion of the ring.

A drive line component for a vehicle, in accordance with the present disclosure, includes a half shaft including a housing having an axially outwardly facing surface, a wheel hub assembly including a wheel bearing having an axially inwardly facing surface, and a ring extending about the half shaft housing. The ring includes a radially inwardly projecting flange portion arranged between the axially outwardly facing surface of the half shaft housing and the axially inwardly facing surface of the wheel bearing, a radially outwardly projecting flange portion, and a transition region extending between the radially inwardly projecting flange portion and the radially outwardly projecting flange portion. The transition region guiding water and debris accumulation away from the axially outwardly facing surface.

In other features, the transition region includes a first portion extending axially inwardly from the radially inwardly projecting flange portion, a second portion extending at an angle toward the radially outwardly extending flange portion, and a third portion including a transition between the first portion and the second portion, the transition having a sharp edge.

In other features, the second portion of the transition region extends at an acute angle from the transition to the radially outwardly extending flange portion.

In other features, the sharp edge forms a substantially 90° angle.

In other features, the half shaft housing includes a surface extending axially between the axially outwardly facing surface and a radially outwardly projecting portion, the transition being arranged closer to the axially outwardly facing surface than to the radially outwardly projecting portion.

In other features, the surface at the axially outwardly facing surface of the housing includes a first thickness portion and the surface adjacent the radially outwardly projecting portion includes a second thickness portion the second thickness portion having a thickness that is less than the first thickness portion, the transition reducing moisture accumulation on the surface adjacent the second thickness portion.

In other features, the ring is formed from a resilient material.

In other features, the housing of the half shaft includes a first outer diameter, and the ring includes an opening having an inner diameter that is smaller than the outer diameter to facilitate a press-fit between the ring and the housing of the half shaft.

In other features, a fastener is configured to secure the wheel bearing to the half shaft, the fastener being torqued to a first selected torque value, a second torque value that is less than the first selected torque value.

In other features, the wheel hub assembly includes an opening surrounded by a recess, the opening being configured to receive the housing of the half shaft and the recess being configured to receive the radially outwardly projecting flange portion of the ring.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic diagram of a vehicle including a drive line having a drive unit including a first half shaft and a second half shaft, in accordance with the present disclosure;

FIG. 2 is a perspective view of a one of the first half shaft and the second half shaft, in accordance with the present disclosure;

FIG. 3 is a side view of a wheel hub connected to the half shaft of FIG. 2, in accordance with the present disclosure;

FIG. 4 is a sectional drawing taken through the line 4-4 in FIG. 3 illustrating a connection between the half shaft of FIG. 2 and the wheel hub of FIG. 3, in accordance with the present disclosure;

FIG. 5 is a detail view of the connection between the half shaft of FIG. 2 and the wheel hub of FIG. 3 illustrating a noise reducing ring, in accordance with the present disclosure; and

FIG. 6 is a perspective view of the noise reducing ring of FIG. 5, in accordance with the present disclosure.

In the drawings, reference numbers may be reused to identify similar and/or identical elements.

### DETAILED DESCRIPTION

Half shafts are prone to producing noise particularly during hard turns. In order to mitigate the noise, a ring mounted to an outboard end of the half shaft. The ring reduces clearances that result in binding. While the noise reducing ring functions to reduce noise, it also may serve as a moisture and debris trap. Moisture and debris sitting on various portions of drive line components can lead to corrosion which, in turn, may reduce an overall service life of the component. The exemplary embodiments disclosed herein provides a solution to noise propagation and reduces corrosion.

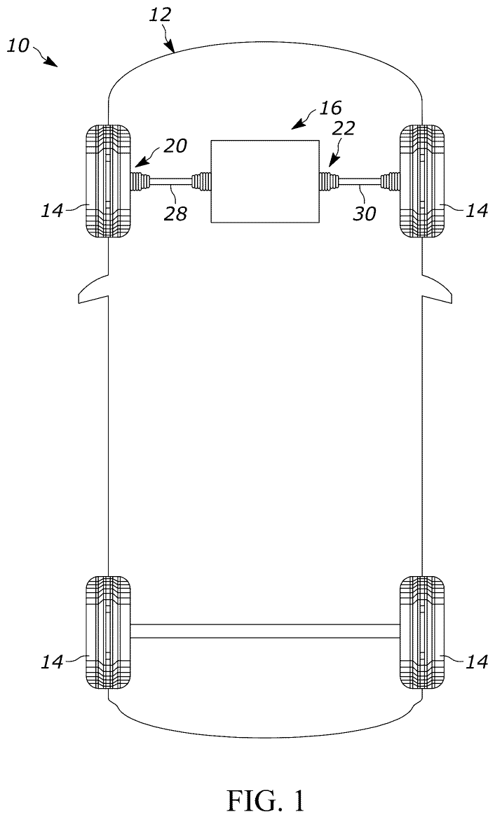

A vehicle, in accordance with a non-limiting example, is generally indicated at 10 in FIG. 1. Vehicle 10 includes a body 12 supported on a plurality of wheels 14. Two of the plurality of wheels 14 are connected to a drive unit 16 that provides motive force to vehicle 10. A first drive line component 20 connects one of the plurality of wheels 14 with drive unit 16 and a second drive line component connects another of the plurality of wheels 14 with drive unit 16. First drive line component 20 includes a first half shaft 28 and second drive line component 22 includes a second half shaft 30. In the non-limiting example shown, the two of the plurality of wheels 14 connected to drive unit 16 are front wheels. As such, vehicle 10 is a front wheel drive (FWD) vehicle.

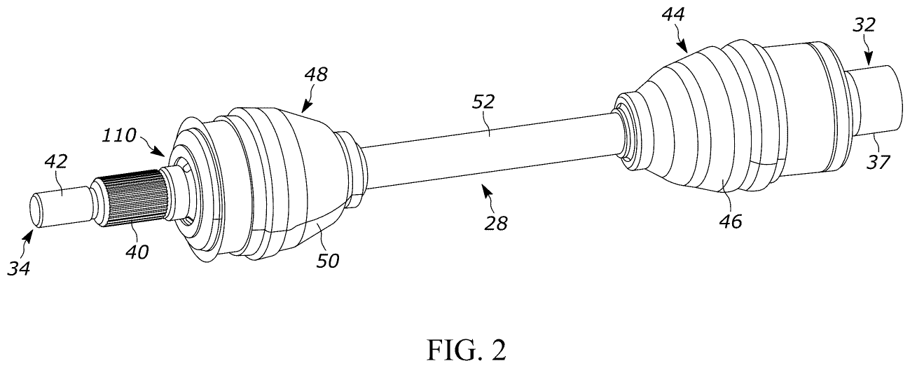

Reference will now follow to FIG. 2 in describing first half shaft 28 with an understanding that second half shaft 30 is similarly formed. First half shaft 28 includes an inboard end 32 and an outboard end 34. A threaded shaft 42 extends axially outwardly from splined shaft 40. Inboard end 32 includes a collar 37 and outboard end 34 includes a splined shaft 40. First half shaft 28 is configured, while rotating, to allow outboard end 34 to pivot at various angles relative to inboard end 32 to accommodate suspension travel and steering angles.

First half shaft 28 includes a first joint assembly 44 arranged adjacent to inboard end 32. First joint assembly 44 may take the form of a tripod joint that is covered by a first protective boot 46. First half shaft 28 includes a second joint assembly 48 arranged near outboard end 34. Second joint assembly 48 may take the form of a constant velocity (CV) joint that is covered by a second protective boot 50. First protective boot and second protective boot 50 shield or protect corresponding ones of first joint assembly 44 and second joint assembly 48 from debris. First protective boot 46 and second protective boot 50 also contain grease used to lubricate first joint assembly 44 and second joint assembly 48, respectively. A shaft 52 extends between first joint assembly 44 and second joint assembly 48.

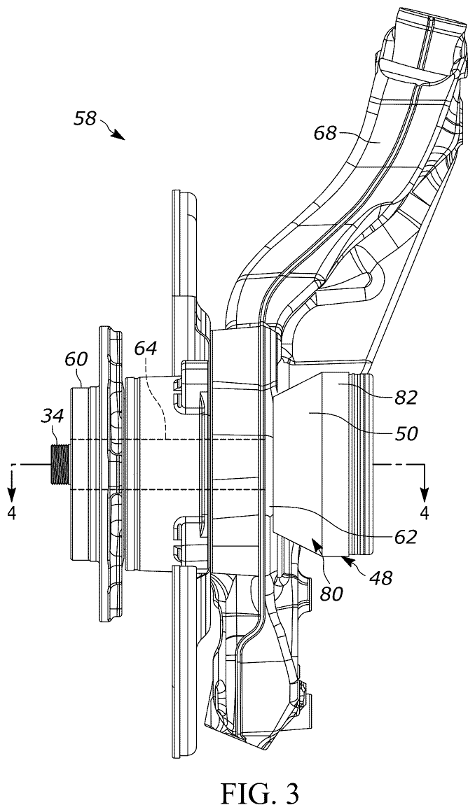

Reference will now follow to FIG. 3 with continued reference to FIG. 2 in describing a wheel hub 58. Wheel hub 58 includes an outboard end portion 60 and an inboard end portion 62. An opening 64 extends through wheel hub 58. Opening 64 provides passage for splined shaft 40. Opening 64 is surrounded by a recess 66. Wheel hub 58 supports a steering knuckle 68 that translates steering commends into the one of the plurality of wheels 14. Outboard end portion 60 supports a wheel bearing 70 that facilitates rotation of first half shaft 28. Wheel bearing 70 includes an axially inwardly facing surface 72 that abuts splined shaft 40 of first half shaft 28 as will be detailed more fully herein. A fastener 74 is mounted to threaded shaft 42 and applies a compressive force to wheel bearing 70.

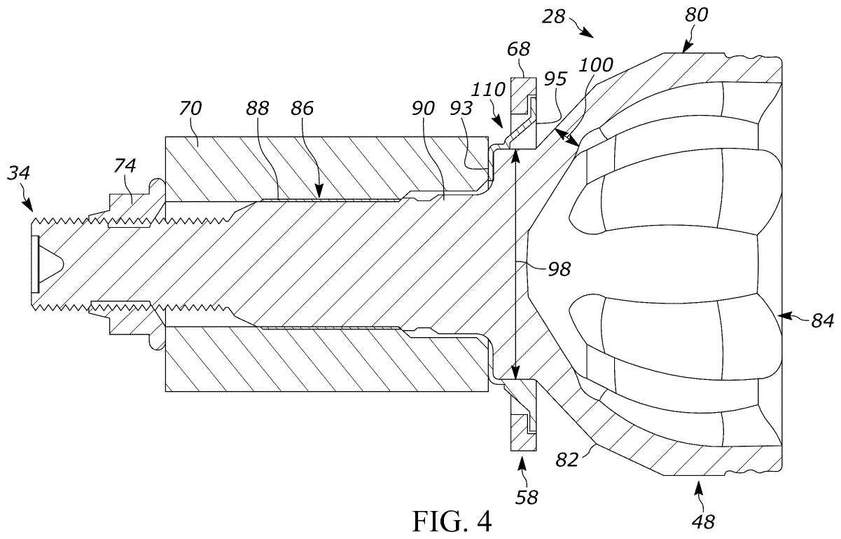

Reference will now follow to FIG. 4 in describing second joint assembly 48. Second joint assembly 48 includes a housing 80 having an outer surface 82 and a hollow interior portion 84 that houses the CV joint of second joint assembly 48. Splined shaft 40 extends from housing 80 and includes a bearing support surface 86 including a first surface portion 88 and a second surface portion 90. Second surface portion 90 extends to an axially outwardly facing surface 93 of housing 80. Housing 80 also includes a radially outwardly facing surface 95 that extends axially inwardly from axially outwardly facing surface 93 forming a shoulder 97. Radially outwardly facing surface 95 includes an outer diameter defining a first thickness 98 of housing 80. A second thickness 100 defined axially through outer surface 82 to hollow interior portion 84. The first thickness is substantially greater than the second thickness.

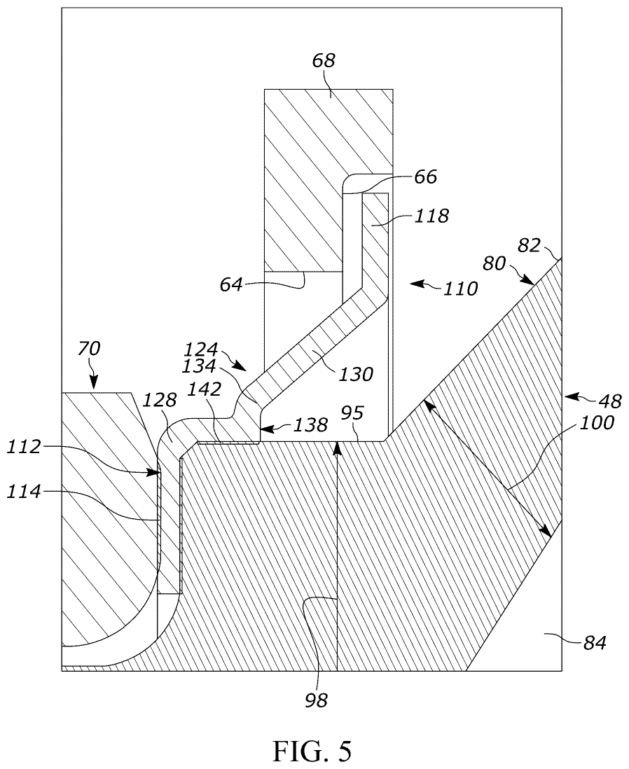

In accordance with a non-limiting example illustrated in FIG. 5, a noise reducing ring 110 is fitted over shoulder 97. Noise reducing ring 110 is formed from, a resilient material and includes a ring body 112 having a radially inwardly projecting flange portion 114, a radially outwardly projecting flange portion 118 and a transition or exclusion region 124. The resilient material may take on various forms including metals such as coated steel and non-metals such as plastic. Transition region 124 extends between and joins radially inwardly projecting flange portion 114 with radially outwardly projecting flange. 118. With this construction, noise reducing ring 110 includes both a washer, e.g., radially inwardly projecting flange portion 114 and a slinger, e.g., transition region 124 and radially outwardly projecting flange portion 118 combined into a single component.

In accordance with the present disclosure, transition region 124 reduces moisture and debris migration between housing 80 and wheel hub 58. Transition region 124 includes a first portion 128 that extends substantially parallel to radially outwardly facing surface 95, a second portion 132 that extends at a non-zero angle relative to radially outwardly facing surface 95, and a third portion 134 that joins first portion 128 with second portion 132.

In accordance with the present disclosure, third portion 134 includes a transition 138 having a sharp edge 142. In a non-limiting example, sharp edge 142 forms a 90° angle in third portion 134. Sharp edge 142 is arranged adjacent to axially outwardly facing surface 93 and is spaced from thinner portions of housing 80 having, for example, second thickness 100. In this manner, any moisture/debris that does accumulate under noise reducing ring 110 that are not removed by virtue of centrifugal forces, may only act on thicker portions of housing 80, such as those having the first thickness. Corrosive forces acting on thicker portions of housing 80 rather than thinner portions, component life may be prolonged.

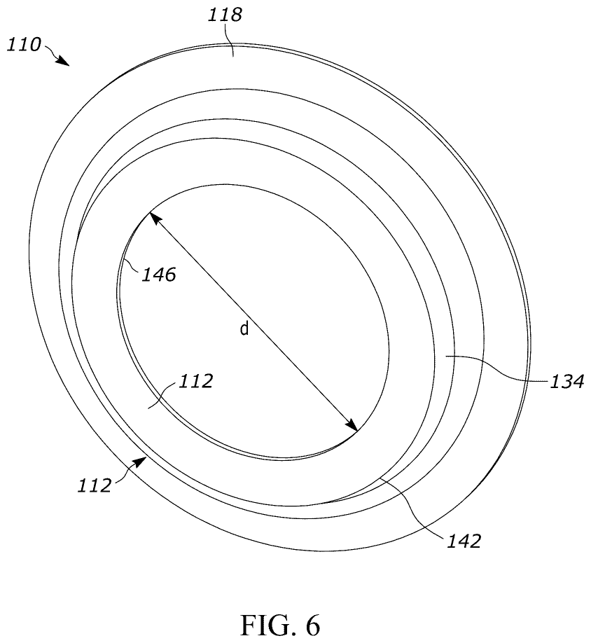

In a non-limiting example illustrated in FIG. 6, noise reducing ring 110 includes a central opening 146 having an inner diameter “ID” including a first dimension. Radially outwardly facing surface 95 of housing 80 includes an outer diameter “OD” having a second dimension that is slightly smaller than the ID of central opening 146. In this manner, noise reducing ring 110 is mounted to housing 80 in a press-fit arrangement. Once mounted, outboard end 34 of first half shaft 28 is passed through opening 64 in wheel hub 58. Wheel bearing 70 is mounted on threaded shaft 42 and nested into wheel hub 58. Fastener 74 is engaged with threaded shaft 42 and tightened against wheel bearing 70 to a selected torque value. Once tightened to the selected torque value, fastener 74 is backed off 45°, and a final torque is applied to seat noise reducing ring 110.

The noise reducing ring in accordance with the present disclosure is formed as single component that is easy to manufacture, easy to install and which ensures that moisture and/or debris that may accumulate on a half-shaft housing is kept away from thinner material regions. In this manner, any corrosion that may occur will act upon thicker more robust regions of the housing which can withstand corrosion for a much longer time than the thinner regions of the housing.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terms “about” and “substantially” are intended to include the degree of error associated with measurement of the particular quantity based upon the equipment available at the time of filing the application. For example, “about” and “substantially” can include a range of ±8% of a given value.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A drive line component for a vehicle comprising:
a half shaft including a housing having an axially outwardly facing surface;
a wheel hub assembly including a wheel bearing having an axially inwardly facing surface; and
a ring extending about the housing of the half shaft, the ring including a radially inwardly projecting flange portion arranged between the axially outwardly facing surface of the half shaft housing and the axially inwardly facing surface of the wheel bearing, a radially outwardly projecting flange portion, and a transition region extending between the radially inwardly projecting flange portion and the radially outwardly projecting flange portion, the transition region including a first portion extending axially inwardly from the radially inwardly projecting flange portion, a second portion extending at an angle toward the radially outwardly projecting flange portion, and a third portion including a transition between the first portion of the transition region and the second portion of the transition region, the transition having a sharp edge.

2. The drive line component according to claim 1, wherein the sharp edge forms a substantially 90° angle.

3. The drive line component according to claim 1, wherein the housing of the half shaft includes a surface extending axially between the axially outwardly facing surface and a radially outwardly projecting portion, the transition being arranged closer to the axially outwardly facing surface than to the radially outwardly projecting portion.

4. The drive line component according to claim 3, wherein the transition reduces moisture retention between the ring and the housing of the half shaft.

5. The drive line component according to claim 4, wherein the surface at the axially outwardly facing surface of the housing includes a first thickness portion and the surface adjacent the radially outwardly projecting portion includes a second thickness portion the second thickness portion having a thickness that is less than the first thickness portion, the transition reducing moisture accumulation on the surface adjacent the second thickness portion.

6. The drive line component according to claim 1, wherein the ring is formed from a resilient material.

7. The drive line component according to claim 1, wherein the housing of the half shaft includes an outer diameter, and the ring includes an opening having an inner diameter that is smaller than the outer diameter to facilitate a press-fit between the ring and the housing of the half shaft.

8. The drive line component according to claim 1, wherein the second portion of the transition region extends at an acute angle between the sharp edge and the radially outwardly projecting flange portion.

9. The drive line component according to claim 1, further comprising a fastener configured to secure the wheel bearing to the half shaft, the fastener being torqued to a first selected torque value, a second torque value that is less than the first selected torque value.

10. The drive line component according to claim 1, wherein the wheel hub assembly includes an opening surrounded by a recess, the opening being configured to receive the housing of the half shaft and the recess being configured to receive the radially outwardly projecting flange portion of the ring.

11. A drive line component for a vehicle comprising:
a half shaft including a housing having an axially outwardly facing surface;
a wheel hub assembly including a wheel bearing having an axially inwardly facing surface; and
a ring extending about the half shaft housing, the ring including a radially inwardly projecting flange portion arranged between the axially outwardly facing surface of the half shaft housing and the axially inwardly facing surface of the wheel bearing, a radially outwardly projecting flange portion, and a transition region extending between the radially inwardly projecting flange portion and the radially outwardly projecting flange portion, the transition region guiding water and debris accumulation away from the axially outwardly facing surface.

12. The drive line component according to claim 11, wherein the transition region includes a first portion extending axially inwardly from the radially inwardly projecting flange portion, a second portion extending at an angle toward the radially outwardly extending flange portion, and a third portion including a transition between the first portion and the second portion, the transition having a sharp edge.

13. The drive line component according to claim 12, wherein the second portion of the transition region extends at an acute angle from the transition to the radially outwardly extending flange portion.

14. The drive line component according to claim 12, wherein the sharp edge forms a substantially 90° angle.

15. The drive line component according to claim 11, wherein the half shaft housing includes a surface extending axially between the axially outwardly facing surface and a radially outwardly projecting portion, the transition being arranged closer to the axially outwardly facing surface than to the radially outwardly projecting portion.

16. The drive line component according to claim 15, wherein the surface at the axially outwardly facing surface of the housing includes a first thickness portion and the surface adjacent the radially outwardly projecting portion includes a second thickness portion the second thickness portion having a thickness that is less than the first thickness portion, the transition reducing moisture accumulation on the surface adjacent the second thickness portion.

17. The drive line component according to claim 11, wherein the ring is formed from a resilient material.

18. The drive line component according to claim 11, wherein the housing of the half shaft includes a first outer diameter, and the ring includes an opening having an inner diameter that is smaller than the outer diameter to facilitate a press-fit between the ring and the housing of the half shaft.

19. The drive line component according to claim 11, further comprising a fastener configured to secure the wheel bearing to the half shaft, the fastener being torqued to a first selected torque value, a second torque value that is less than the first selected torque value.

20. The drive line component according to claim 11, wherein the wheel hub assembly includes an opening surrounded by a recess, the opening being configured to receive the housing of the half shaft and the recess being configured to receive the radially outwardly projecting flange portion of the ring.
